(19) United States
(12) Patent Application Publication
(10) Pub. No.: US 2022/0321961 A1
(43) Pub. Date: Oct. 6, 2022

(54) INFORMATION PROCESSING DEVICE, INFORMATION PROCESSING METHOD, AND ARTIFICIAL INTELLIGENCE FUNCTION-MOUNTED DISPLAY DEVICE

(71) Applicant: Sony Group Corporation, Tokyo (JP)

(72) Inventors: Tatsuya HAMA, Tokyo (JP); Tatsushi NASHIDA, Tokyo (JP); Masanori MATSUSHIMA, Tokyo (JP); Goro TAKAKI, Tokyo (JP); Satoshi AKAGAWA, Tokyo (JP); Yoshiyuki KOBAYASHI, Tokyo (JP)

(73) Assignee: Sony Group Corporation, Tokyo (JP)

(21) Appl. No.: 17/642,231

(22) PCT Filed: Jul. 7, 2020
(86) PCT No.: PCT/JP2020/026614

§ 371 Date: Mar. 11, 2022

(30) Foreign Application Priority Data
Sep. 19, 2019 (JP) 2019-170035

(51) Int. Cl. H04N 21/466; H04N 21/45; H04N 21/422; H04N 21/442

(52) U.S. Cl. CPC H04N 21/4666; H04N 21/4532; H04N 21/42201; H04N 21/44218

(57) ABSTRACT

Provided is an information processing device for effectively using a television that is in a non-use state by using an artificial intelligence function.

An information processing device for controlling operation of a display device by using an artificial intelligence function, includes an acquisition section that acquires sensor information, and an inferring section that infers content, which is to be outputted by the display device according to a use state, by using the artificial intelligence function, on the basis of the sensor information. The inferring section infers content, which is to be outputted by the display device that is in a non-use state, on the basis of information regarding a room where the display device is placed. The information regarding the room is included in the sensor information.

### TECHNICAL FIELD

A technology disclosed herein (hereinafter, referred to as “present disclosure”) relates to an information processing device, an information processing method, and an artificial intelligence function-mounted display device using an artificial intelligence function.

### BACKGROUND ART

It is such a long time since televisions became widespread. In recent years, upsizing of television screens has been promoted. Further, quality enhancement including image-quality enhancement to provide a super resolution technology or a high dynamic range (for example, see PTL 1) and sound-quality enhancement to achieve band width extension (high resolution) or the like (for example, see PTL 2) also has been promoted.

Televisions are mainly used as devices for screen display of information programs such as news shows, entertainment programs such as movies, drama series, or music programs, and content delivered by streaming distribution or content reproduced from media such as Blu-ray discs. However, televisions are not used all day long. A state in which a television that is not displaying any information on a screen thereof occupies a certain space in a room, continues for a long non-use state. A large screen of a television that is in a non-use state is not useful. The presence of the screen which is large and black oppresses or overwears a user near the television. The screen can give an unpleasant feeling to the user.

### CITATION LIST

### Patent Literature

### [PTL 1]

Japanese Patent Laid-Open No. 2019-23798

### [PTL 2]

Japanese Patent Laid-Open No. 2017-203999

### [PTL 3]

Japanese Patent Laid-Open No. 2015-92529

### [PTL 4]

Japanese Patent No. 4915143

### [PTL 5]

Japanese Patent Laid-Open No. 2007-143010

### SUMMARY

### Technical Problems

An object of a technology according to the present disclosure is to provide an information processing device, an information processing method, and an artificial intelligence function-mounted display device for effectively using a television that is in a non-use state by using an artificial intelligence function.

### Solution to Problems

The technology according to the present disclosure has been made in view of the aforementioned technical problems. A first aspect of the technology is an information processing device for controlling operation of a display device by using an artificial intelligence function. The device includes an acquisition section that acquires sensor information, and an inferring section that infers content, which is to be outputted by the display device according to a use state, by using the artificial intelligence function, on the basis of the sensor information.

The inferring section infers content, which is to be outputted by the display device that is in a non-use state, by using the artificial intelligence function. The information processing device according to the first aspect may further include a second inferring section that infers a use state of the display device by using the artificial intelligence function, on the basis of the sensor information.

The inferring section infers content, which is to be outputted by the display device that is in a non-use state, by using the artificial intelligence function, on the basis of information regarding a room where the display device is placed. The information regarding the room is included in the sensor information. The information regarding the room includes at least one of information regarding a piece of furniture or a furnishing in the room, a raw material of the piece of furniture or the furnishing, and information regarding a light source in the room.

In addition, the inferring section infers video content, which is to be displayed on the display device that is in a non-use state, by using the artificial intelligence function, further on the basis of information regarding a user of the display device. The information regarding the user is included in the sensor information. Here, the information regarding the user includes at least one of information regarding a user state or information regarding a user profile.

Further, a second aspect of the technology according to the present disclosure is an information processing method for controlling operation of a display device by using an artificial intelligence function, the method including an acquisition step of acquiring sensor information, and an inferring step of inferring content, which is to be outputted by the display device, by using the artificial intelligence function, on the basis of the sensor information.

Moreover, a third aspect of the technology according to the present disclosure is an artificial intelligence function-mounted display device including a display section, an acquisition section that acquires sensor information, and an inferring section that infers content, which is to be outputted by the display section, by using an artificial intelligence function, on the basis of the sensor information.

### Advantageous Effects of Invention

The technology according to the present disclosure can provide an information processing device, an information processing method, and an artificial intelligence function-mounted display device that implement a function for making a television that is in a non-use state blend into an interior, by using an artificial intelligence function.

It is to be noted that the effects described herein are just examples, effects provided by the technology according to the present disclosure are not limited to these described effects. Besides the aforementioned effects, an additional effect may also be provided by the technology according to the present disclosure.

Other objects, features, and advantages of the technology according to the present disclosure will become apparent from the detailed description based on the embodiments and the attached drawings which are described later.

### BRIEF DESCRIPTION OF DRAWINGS

FIG. 1 is a diagram depicting a configuration example of a system for video content viewing.

FIG. 2 is a diagram depicting a configuration example of a television receiving device 100.

FIG. 3 is a diagram depicting an application example of a panel speaker technology.

FIG. 4 is a diagram depicting a configuration example of a sensor group 400 that is installed in the television receiving device 100.

FIG. 5 is a diagram depicting a configuration example of an interior assimilation system 500.

FIG. 6 is a diagram depicting a configuration example of a content deriving neural network 600.

FIG. 7 is a diagram depicting a configuration example of an artificial intelligence system 700 using a cloud.

FIG. 8 is a diagram depicting an example of content to be outputted to make the television receiving device 100 that is in a non-use state blend into an interior.

FIG. 9 is a diagram depicting an example of content to be outputted in order to make the television receiving device 100 that is in a non-use state blend into an interior.

FIG. 10 is a diagram depicting an example of content to be outputted in order to make the television receiving device 100 that is in a non-use state blend into an interior.

### DESCRIPTION OF EMBODIMENTS

Hereinafter, the details of embodiments according to the present disclosure will be explained with reference to the drawings.

### A. System Configuration

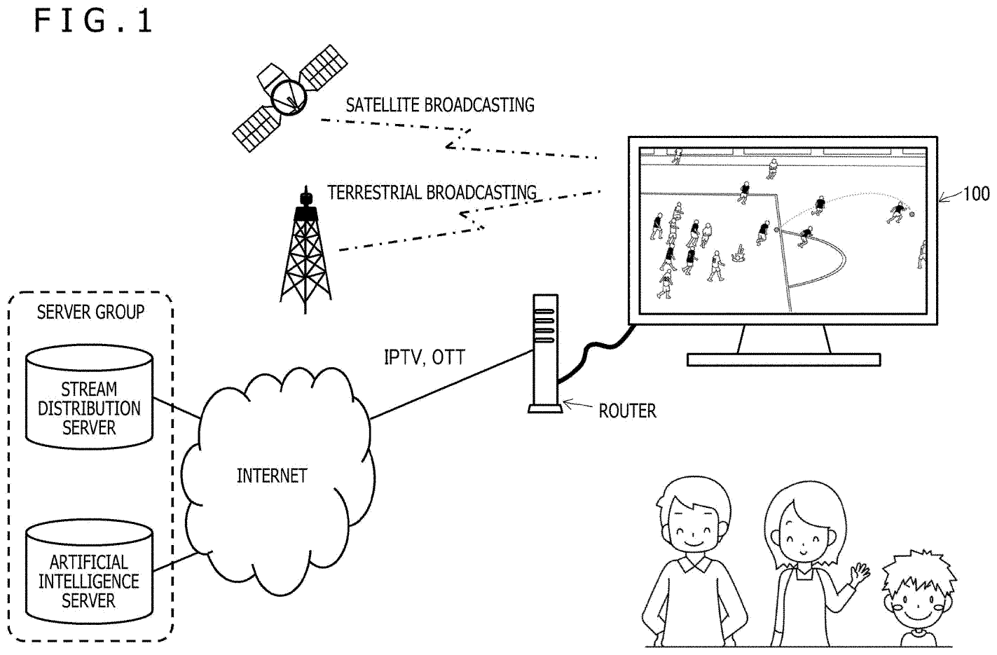

FIG. 1 schematically depicts a configuration example of a system for video content viewing.

A television receiving device 100 is placed in a living room where family members gather, or in a user's private room in a house, for example. The television receiving device 100 is equipped with a large screen on which video content is displayed, and a speaker which outputs sounds. For example, the television receiving device 100 has a built-in tuner that tunes and receives broadcast signals, or a set top box having a tuner function is externally connected to the television receiving device 100, so that a broadcasting service provided by a television station can be used. The broadcast signals may be terrestrial waves or may be satellite waves.

Further, the television receiving device 100 can be used for a broadcasting-type video distribution service using a network such as IPTV or OTT (Over The Top), for example. Therefore, the television receiving device 100 is equipped with a network interface card to use communication based on an existing communications standard such as Ethernet (registered trademark) or Wi-Fi (registered trademark). Accordingly, the television receiving device 100 is interconnected with an external network such as the internet via a router or via an access point. Regarding a functional aspect of the television receiving device 100, the television receiving device 100 serves as a content acquisition device, a content reproduction device, or a display device in which a display having a function of acquiring or reproducing various types of content by acquiring various types of video and audio reproduction content through streaming or downloading via broadcast waves or the internet, and presenting the acquired content to a user, is mounted.

On the internet, a stream distribution server that distributes video streams is installed to provide a broadcast-type video distribution service to the television receiving device 100.

Further, on the internet, many servers for providing various services are set. One example of the servers is a stream distribution server that provides a broadcast-type video stream distribution service using a network such as IPTV or OTT. The television receiving device 100 starts a browser function, and issues an HTTP (Hyper Text Transfer Protocol) request, for example, to the stream distribution server, so that the stream distribution service is available.

In addition, the presence of an artificial intelligence server that provides an artificial intelligence function to a client over the internet (or on a cloud), is also assumed in the present embodiment. Here, the term, artificial intelligence function refers to an artificial function of learning, inferring, creating data, creating a plan, etc., which is normally exerted by a human brain, but is implemented by software or hardware. Moreover, a neural network that performs deep learning (DL) using a model that simulates a human brain neural circuit, for example, is installed in the artificial intelligence server. The neural network has a mechanism in which artificial neurons (nodes) forming a network by synaptic connection gain a skill for solving a problem while the strength of the synaptic connection is varied through learning. The neural network is capable of automatically inferring a rule for solving a problem by repeatedly performing learning. It is to be noted that the term “artificial intelligence server” herein does not always refer to a single server device. The artificial intelligence server may have a form of a cloud that provides a cloud computing service, for example.

### B. Configuration of Television Receiving Device

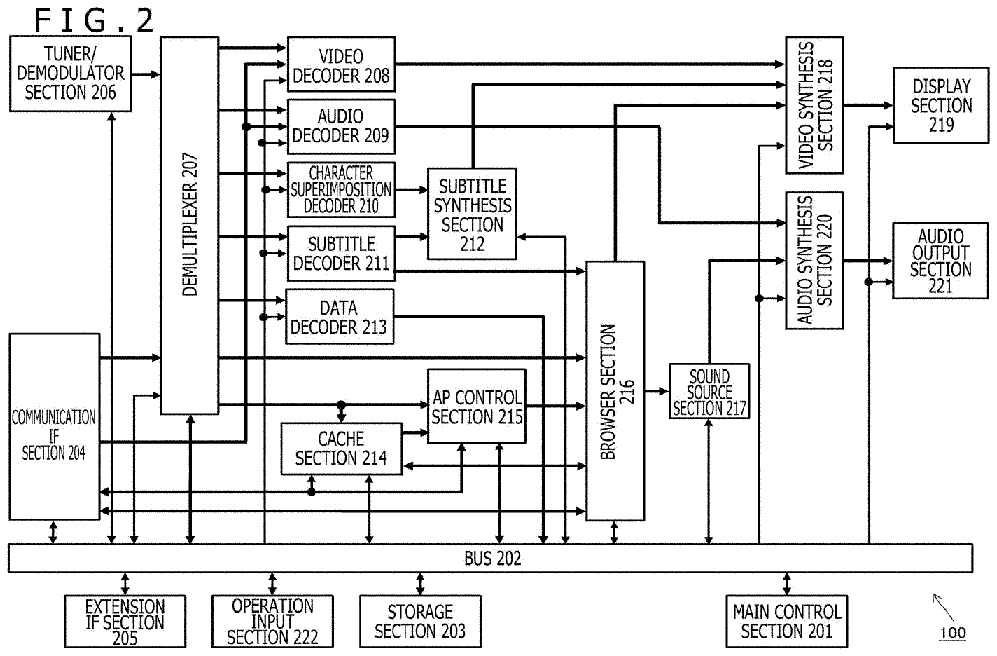

FIG. 2 depicts a configuration example of the television receiving device 100. The television receiving device 100 includes a main control section 201, a bus 202, a storage section 203, a communication interface section (IF) 204, an extension interface section (IF) 205, a tuner/demodulator section 206, a demultiplexer (DEMUX) 207, a video decoder 208, an audio decoder 209, a character superimposition decoder 210, a subtitle decoder 211, a subtitle synthesis section 212, a data decoder 213, a cache section 214, an application (AP) control section 215, a browser section 216, a sound source section 217, a video synthesis section 218, a display section 219, an audio synthesis section 220, an audio output section 221, and an operation input section 222. It is to be noted that the tuner/demodulator section 206 may be an externally connection type. For example, an external device such as a set top box equipped with a tuner and demodulating function, may be connected to the television receiving device 100.

The main control section 201 includes a controller, a ROM (Read Only Memory) (including a rewritable ROM such as an EEPROM (Electrically Erasable Programmable ROM)), and a RAM (Random Access Memory), for example. The main control section 201 comprehensively controls operation of the entire television receiving device 100 according to a prescribed operation program. The controller includes a CPU (Central Processing Unit), an MPU (Micro Processing Unit), a GPU (Graphics Processing Unit), or a GPGPU (General Purpose Graphic Processing Unit), for example. The ROM is a nonvolatile memory in which a basic operation program of an operating system (OS) or the like, and any other operating program are stored. An operation setting value that is required for operating the television receiving device 100 may be stored in the ROM. The RAM is a work area that is used when the OS or any other operation program is executed. The bus 202 is a data communication path for data exchange between the main control section 201 and each section in the television receiving device 100.

The storage section 203 includes a nonvolatile storage device such as a flash ROM, an SSD (Solid State Drive), or an HDD (Hard Disc Drive). The storage section 203 stores an operating program and an operation setting value for the television receiving device 100, and personal information regarding a user who uses the television receiving device 100, etc. The storage section 203 further stores an operating program downloaded via the internet, and various kinds of data created according to the operating program, etc. Moreover, the storage section 203 can store content such as a moving image, a stationary image, or audio acquired by streaming or downloading via broadcast waves or the internet.

The communication interface section 204 is connected to the internet via the router (explained above), and exchanges data with a server device or any other communication device on the internet. In addition, the communication interface section 204 is configured to also acquire a data stream of a program transmitted via a communication line. Connection with the router may be established by wired connection using Ethernet (registered trademark) or the like, or wireless connection using Wi-Fi (registered trademark) or the like. The main control section 201 is capable of retrieving data on a cloud via the communication interface section 204, on the basis of resource identification information such as an URL (Uniform Resource Locator) or URI (Uniform Resource Identifier). That is, the communication interface section 204 functions as a data retrieving section.

The tuner/demodulator section 206 receives a broadcast wave of terrestrial broadcasting, satellite broadcasting, or the like via an antenna (not depicted), and performs tuning (channel selection) for a channel of a service (e.g. a broadcasting station) desired by a user under the control of the main control section 201. In addition, the tuner/demodulator section 206 acquires a broadcast data stream by demodulating the received broadcast wave. It is to be noted that the television receiving device 100 may have a configuration equipped with a plurality of tuner/demodulator sections (i.e. a multiplex tuner) in order to simultaneously display a plurality of screens or to record a program in a competing timeslot. In addition, the tuner/demodulator section 206 may be a set top box (explained above) that is externally connected to the television receiving device 100.

The demultiplexer 207 distributes a video stream, an audio stream, a character superimposition data stream, and a subtitle data stream, which are real-time presentation elements, to the video decoder 208, the audio decoder 209, the character superimposition decoder 210, and the subtitle decoder 211, respectively, on the basis of a control signal included in an inputted broadcast data stream. The data inputted to the demultiplexer 207 includes data of a broadcast service and data of a distribution service using IPTV or OTT. The former data is received through tuning, and demodulated by the tuner/demodulator section 206, and then, is inputted to the demultiplexer 207. The latter data is received by the communication interface section 204, and then, is inputted to the demultiplexer 207. In addition, the demultiplexer 207 reproduces a multimedia application or file data which is a component element thereof, and outputs the reproduced application or data to the application control section 215 or temporarily stores the reproduced application or data in the cache section 214.

The video decoder 208 decodes the video stream inputted from the demultiplexer 207, and outputs video information. In addition, the audio decoder 209 decodes the audio stream inputted from the demultiplexer 207, and outputs audio data. In digital broadcasting, in compliance with the MPEG2 System standard, for example, an encoded video stream and an encoded audio stream are multiplexed, and transmitted or distributed. The video decoder 208 and the audio decoder 209 are configured to execute respective decoding processes on the encoded video stream and the encoded audio stream demultiplexed by the demultiplexer 207, in accordance with a standardized decoding method. It is to be noted that the television receiving device 100 may include a plurality of the video decoders 208 and the audio decoders 209 to simultaneously execute respective decoding processes of multiple types of video streams and audio streams.

The character superimposition decoder 210 decodes the character superimposition data stream inputted from the demultiplexer 207, and outputs character superimposition information. The subtitle decoder 211 decodes the subtitle data stream inputted from the demultiplexer 207, and outputs subtitle information. The subtitle synthesis section 212 executes a synthesis process, on the basis of the character superimposition information outputted from the character superimposition decoder 210 and the subtitle information outputted from the subtitle decoder 211.

The data decoder 213 decodes a data stream multiplexed into an MPEG-2 TS stream with a video and audio. For example, the data decoder 213 reports, to the main control section 201, a result obtained by decoding a general-purpose event message stored in a descriptor area in a PMT (Program Map Table), which is one of PSI (Program Specific Information) tables.

The application control section 215 receives, from the demultiplexer 207, control information included in a broadcast data stream, or acquires the control information from a server device on the internet via the communication interface section 204, and interprets the control information.

In accordance with an instruction from the application control section 215, the browser section 216 presents a multimedia application file or file data which is a component element thereof acquired from the server device on the internet via the cache section 214 or the communication interface section 204. The term, multimedia application file, herein, refers to an HTML (Hyper Text Markup Language) document, a BML (Broadcast Markup Language) document, or the like, for example. In addition, the browser section 216 is configured to also reproduce audio data of the application by working on the sound source section 217.

The video synthesis section 218 receives the video information outputted from the video decoder 208, the subtitle information outputted from the subtitle synthesis section 212, and the application information outputted from the browser section 216, and executes a selection or superimposition process on these pieces of inputted information, as appropriate. The video synthesis section 218 includes a video RAM (not depicted). On the basis of video information inputted to the video RAM, display driving of the display section 219 is performed. In addition, under the control of the main control section 201, the video synthesis section 218 also performs a superimposition process, if needed, on an EPG (Electronic Program Guide) screen and screen information regarding graphics such as OSD (On Screen Display) generated by an application executed by the main control section 201.

It is to be noted that, before or after performing the superimposition process on information regarding a plurality of screens, the video synthesis section 218 may perform a super-resolution process of increasing the resolution of an image, or a high-quality image process such as dynamic range enhancement to increase the luminance dynamic range of an image.

The display section 219 presents, to a user, a screen displaying the video information subjected to the selection or superimposition process at the video synthesis section 218. For example, the display section 219 is a display device including a liquid crystal display, an organic EL (Electro-Luminescence) display, or a light-emitting display (for example, see PTL 3) using fine LED (Light Emitting Diode) elements as pixels. In addition, a display device to which a partial driving technology of dividing a screen into a plurality of regions and controlling the brightness of each region is applied, may be used as the display section 219. A display using a transmissive liquid crystal panel have an advantage of improving the luminance contrast by making a back light corresponding to a high-signal level region bright while making a back light corresponding to a low-signal level region dark. In such a partial driving display device, a boost-up technology in which power saved in a dark part is allocated to a high-signal level region to illuminate intensively is used. Thus, a high dynamic range can be achieved by locally increasing the illuminance of a part displayed white (while keeping the total output power of the backlights constant) (see PTL 4, for example).

The audio synthesis section 220 receives the audio data outputted from the audio decoder 209 and the audio data of the application reproduced by the sound source section 217, and performs a selection or synthesis process thereon, as appropriate. It is to be noted that the audio synthesis section 220 may perform a sound-quality increasing process such as bandwidth extension (high resolution) on the inputted audio data or audio data to be outputted.

The audio output section 221 is used for audio outputting of program content or data broadcast content received through tuning by the tuner/demodulator section 206, or for outputting of audio data (a voice guidance, a synthesized voice of a voice agent, or the like) processed by the audio synthesis section 220. The audio output section 221 includes an acoustic generating element such as a speaker. For example, the audio output section 221 may be a speaker array (multi-channel speaker or super multi-channel speaker) formed by combining a plurality of speakers together. At least one or all of the speakers may be externally connected to the television receiving device 100. In a case where the audio output section 221 is equipped with a plurality of speakers, the audio output section 221 reproduces an audio signal by using a plurality of output channels. Accordingly, a sound image can be localized. In addition, when the speakers are multiplexed with an increase of the number of channels, a sound field can be controlled at a higher resolution. For example, the external speaker may be a soundbar stationarily placed in front of a television, or may be a wireless speaker wirelessly connected to the television. In addition, the external speaker may be connected to any other audio product via an amplifier or the like. Alternatively, the external speaker may be a smart speaker, a wireless headphone/headset, a tablet, a smartphone, or a PC (Personal Computer) equipped with a speaker to receive audio inputs, or may be a generally-called smart household electric appliance such as a refrigerator, a washing machine, an air conditioner, a vacuum cleaner, or a lighting appliance, or an IoT (Internet of Things) household electric device.

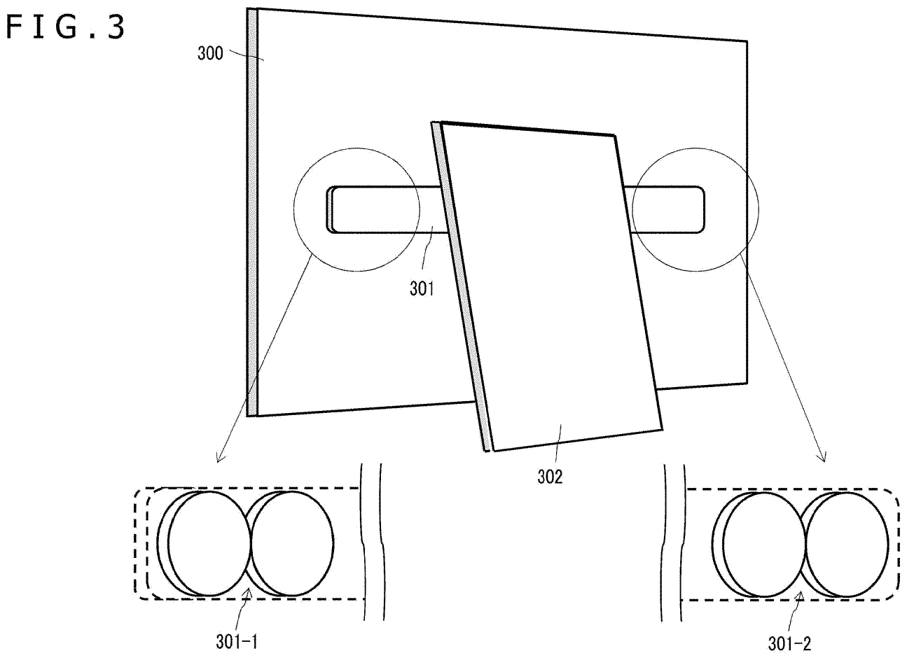

Not only a cone-type speaker but also a flat panel-type speaker (for example, see PTL 5) can be used as the audio output section 221. Obviously, a speaker array formed by combining different types of speakers together can also be used as the audio output section 221. Moreover, the speaker array may include a speaker that performs audio outputting by vibrating the display section 219 with use of one or more vibration exciters (actuators) that generate vibration. The vibration exciters (actuators) may separately be fitted to the display section 219. FIG. 3 depicts an example of application of a panel speaker to a display. A display 300 is supported by a stand 302 on the rear surface thereof. A speaker unit 301 is mounted on the rear surface of the display 300. A vibration exciter 301-1 and a vibration exciter 301-2 are disposed at the left end and the right end of the speaker unit 301, respectively, whereby a speaker array is formed. The vibration exciters 301-1 and 301-2 vibrate the display 300 on the basis of left and right audio signals, respectively, so that sound outputting can be performed. The stand 302A may have a built-in subwoofer that outputs a low-pitched sound. It is to be noted that the display 300 corresponds to the display section 219 using an organic EL element.

Referring back to FIG. 2, the configuration of the television receiving device 100 will be explained. Through the operation input section 222, a user inputs an operation instruction to the television receiving device 100. For example, the operation input section 222 includes a remote control reception section that receives a command transmitted from a remote controller (not depicted), and an operation key having arranged button switches. In addition, the operation input section 222 may include a touch panel superimposed on the screen of the display section 219. The operation input section 222 may further include an external input device such as a keyboard connected to the extension interface section 205.

The extension interface section 205 is an interface group for extending the functions of the television receiving device 100. For example, the extension interface section 205 includes an analog video-and-audio interface, a USB (Universal Serial Bus) interface, a memory interface, etc. The extension interface section 205 may include a digital interface including a DVI terminal, an HDMI (registered trademark) terminal, a Display Port (registered trademark) terminal, or the like.

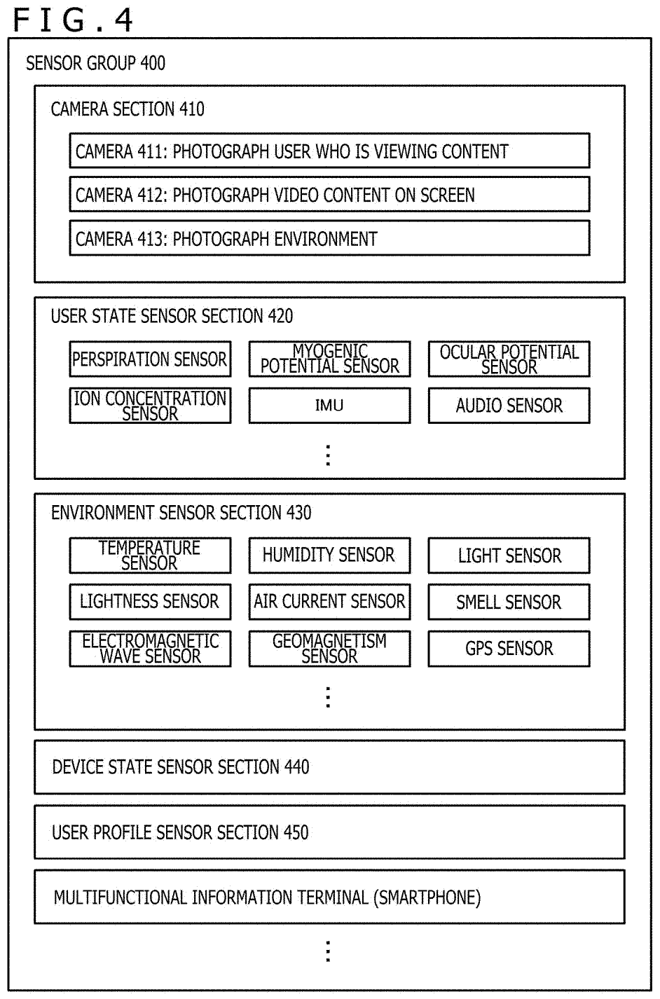

In the present embodiment, the extension interface 205 is also used as an interface for taking sensor signals from various sensors included in a sensor group (see the explanation below and FIG. 4). It is assumed that the sensors include both a sensor that is mounted inside the body of the television receiving device 100 and a sensor that is externally connected to the television receiving device 100. Examples of the sensor that is externally connected also include a sensor that is incorporated in a CE (Consumer Electronics) device or an IoT device that is present in the same space as the television receiving device 100. The extension interface 205 may take a sensor signal that has undergone signal processing such noise elimination and has been digitally converted, or may take a sensor signal that is unprocessed PAW data (analog waveform signal).

### C. Sensing Function

One object of the technology according to the present disclosure is to cause the television receiving device 100 that is in a non-use state (a time period during which a user is not viewing any content), to function as an interior decoration that matches the remaining interior decorations in a room where the television receiving device 100 is placed, or that is suitable to tastes of a user. The television receiving device 100 is equipped with various sensors for detecting the remaining interior decorations in the room or for detecting the tastes of the user.

It is to be noted that, unless specifically stated otherwise, when a term “user” is simply used in the present specification, the term refers to a viewer who is viewing (or is going to view) video content being displayed on the display section 219.

FIG. 4 depicts a configuration example of a sensor group 400 mounted on the television receiving device 100. The sensor group 400 includes a camera section 410, a user state sensor section 420, an environment sensor section 430, a device state sensor section 440, and a user profile sensor section 450.

The camera section 410 includes a camera 411 that photographs a user who is viewing video content being displayed on the display section 219, a camera 412 that photographs video content being displayed on the display section 219, and a camera 413 that photographs a room (or installation environment) where the television receiving device 100 is placed.

The camera 411 is disposed around the center of the upper edge of the screen of the display section 219, for example, and preferably photographs the user who is viewing the video content. The camera 412 is disposed so as to face the screen of the display section 219, for example, and photographs the video content that the user is viewing. Alternatively, the user may put on goggles equipped with the camera 412. In addition, it is assumed that the camera 412 also has a function of recording sounds of the video content. Also, the camera 413 includes an all-sky camera or a wide-angle camera, for example, and photographs the room (or the installation environment) where the television receiving device 100 is placed. Alternatively, the camera 413 may be placed on a camera table (platform) that can be rotationally driven about roll, pitch, and yaw axes, for example. However, in a case where the environment sensor 430 can acquire sufficient environmental data or in a case where environmental data itself is unnecessary, the camera 410 is not required.

The user state sensor section 420 includes one or more sensors that acquire state information regarding a user state. For example, the user state sensor section 420 is intended to acquire state information such as a user working state (whether or not the user is viewing video content), a user action state a movement state such as standing still, walking, or running, the open or closed state of eyelids, the direction of the visual line, or whether the pupils are large/small), a mental state (an impression level, an excitement level, or an arousal level indicating how deeply the user is absorbed in or is concentrating on the video content, and feelings, emotions, etc.), and a physiological condition. The user state sensor section 420 may include various sensors such as a perspiration sensor, a myogenic potential sensor, an ocular potential sensor, a brain wave sensor, an exhalation sensor, a gas sensor, an ion concentration sensor, an IMU (inertial measurement unit) that measures a behavior of the user, and an audio sensor (e.g. a microphone) that collects a user speech. It is to be noted that the microphone is not necessarily integrated with the television receiving device 100, and may be mounted on a product such as a sound bar formed so as to be placed in the front of a television. In addition, an external microphone-mounted device that can be connected wiredly or wirelessly may be used. Examples of the external microphone-mounted device include a smart speaker or a wireless headphone/headset on which a microphone is mounted to receive an audio input, a tablet, a smartphone, a PC, a generally-called smart appliance, such as a refrigerator, a washing machine, an air conditioner, a vacuum cleaner, or a lighting tool, and an IoT household electric appliance.

The environment sensor section 430 includes various sensors that measure information related to an environment such as the room where the television receiving device 100 is placed. The environment sensor section 430 includes a temperature sensor, a humidity sensor, a light sensor, a lightness sensor, an air current sensor, a smell sensor, an electromagnetic wave sensor, a geomagnetism sensor, a GPS (Global Positioning System) sensor, an audio sensor (e.g. a microphone) that collects the surrounding sounds, and the like, for example.

The device state sensor section 440 includes one or more sensors that acquire an internal state of the television receiving device 100. Alternatively, a circuit component such as the video decoder 208 or the audio decoder 209 that has a function of outputting the state of an input signal, an input-signal processing state to the outside, or the like, may serve as a sensor for detecting a device internal state. In addition, the device state sensor section 440 may be configured to further detect an operation that the user has performed for the television receiving device 100 or any other device, or save the history of operations that the user has performed in the past.

The user profile sensor section 450 detects profile information regarding the user who is viewing the video content on the television receiving device 100. The user profile sensor section 450 does not necessarily include a sensor element. The user profile sensor section 450 may detect a user profile such as the age or sex of the user, on the basis of a user's face image photographed by the camera 411 or a user's speech collected by the audio sensor. In addition, a user profile acquired through a multi-functional information terminal such as a smartphone, which is carried by the user, may be acquired through cooperation between the television receiving device 100 and the smartphone. However, the user profile sensor section does not have to detect confidential information related to the privacy or security of the user. Moreover, a profile of the same user does not have to be detected each time the user views video content. User profile information once acquired may be saved in an EEPROM (previously explained) of the main control section 201, for example.

In addition, a multi-functional information terminal such as a smartphone, which is carried by the user, may be used as the user state sensor section 420, the environment sensor section 430, or the user profile sensor section 450, through cooperation between the television receiving device 100 and the smartphone. For example, sensor information acquired by a sensor incorporated in the smartphone, and data being managed by a health care function (e.g. pedometer) application, a calendar application, a schedule book application, a memo application, an e-mail application, a browser history application, an SNS (Social Network Service) application, etc., may be added to the user state data or environment data. In addition, a sensor incorporated in a CE device or an IoT device that is present in the same space as the television receiving device 100 may be used as the user state sensor section 420 or the environment sensor section 430. In addition, an interphone sound may be detected, or a visitor may be detected through communication with an interphone system.

### D. Interior Assimilation System

The television receiving device 100 is mainly used as a device for screen display of information programs such as news shows, entertainment programs such as movies, drama series, or music programs, and content delivered by streaming distribution or content reproduced from media such as Blu-ray discs. However, the television receiving device 100 is not used all day long. A state in which the television receiving device 100 that is not displaying any information on the screen thereof occupies a certain space in a room and continues for a long non-use state. A large screen of the television receiving device 100 that is in a non-use state is not useful. The presence of the screen which is large and black oppresses or overwears a user near the television receiving device 100. The screen can give an unpleasant feeling to the user.

In contrast, in the technology according to the present disclosure, video or audio content is outputted by the television receiving device 100 that is in a non-use state (a time period during which a user is not viewing any content). Accordingly, the television receiving device 100 becomes an interior decoration that matches the remaining interior decorations in the room or that is suitable to the tastes of the user, so that the television receiving device 100 can blend into the interior.

In the present embodiment, the television receiving device 100 is equipped with various sensors for detecting the remaining interior decorations in the room or detecting the tastes of the user. In addition, whether or not the television receiving device 100 is in a non-use state is basically determined on the basis of whether the device is on or off. However, a state in which the user is not closely viewing content being displayed on the screen of the television receiving device 100 (or a state in which a closely-viewing level is lower than a prescribed value) also may be regarded as a non-use state. Detection signals obtained by various sensors may be used to determine a non-use state of the television receiving device 100.

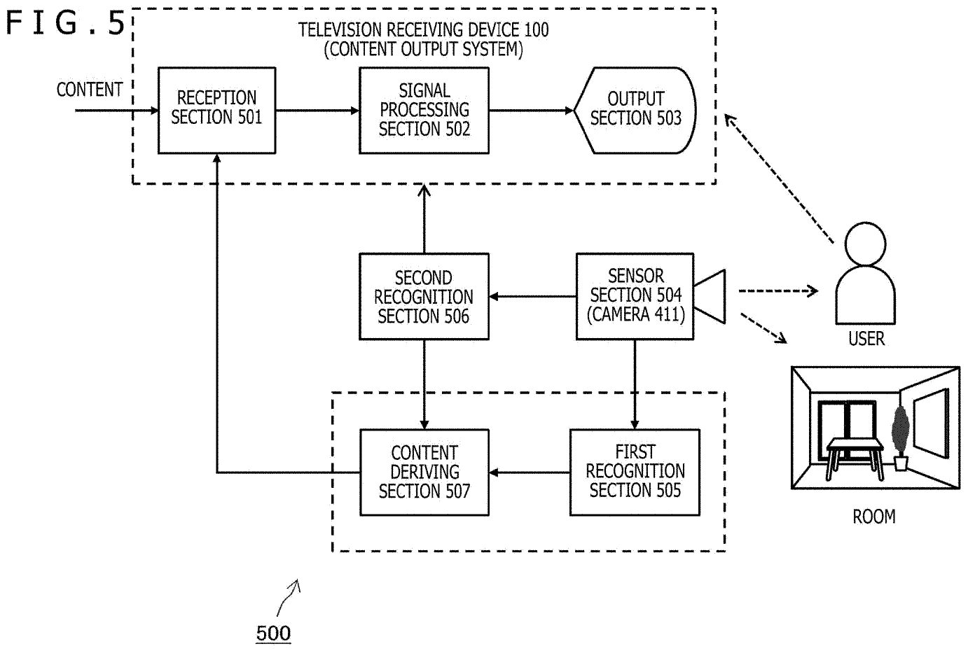

FIG. 5 schematically depicts a configuration example of an interior assimilation system 500 for making the television receiving device 100 blend into the interior of a room. The depicted interior assimilation system 500 in the figure includes the components of the television receiving device 100 in FIG. 2 and a device (e.g. a server device on a cloud) external to the television receiving device 100, if needed.

The reception section 501 receives video content. The video content includes broadcast content transmitted from a broadcast station (e.g. a broadcast tower or a broadcast satellite), and streaming content delivered from a stream distribution server such as an OTT service. Further, the reception section 501 divides (demultiplexes) a received signal into a video stream and an audio stream, and outputs the streams to a signal processing section 502 at a post-stage thereof. For example, the reception section 501 includes the tuner/demodulator section 206, the communication interface section 204, and the demultiplexer 207 of the television receiving device 100.

For example, the signal processing section 502 includes the video decoder 2080 and the audio decoder 209 of the television receiving device 100. The signal processing section 502 decodes the video data stream and the audio data stream inputted from the reception section 501, and outputs the video data and audio data to the output section 503. It is to be noted that the signal processing section 502 may additionally perform an image-quality increasing process such as super-resolution processing or dynamic range enhancement, and a sound-quality increasing process such as band width extension (high resolution), on the decoded video and audio data.

For example, the output section 503 includes the display section 219 and the audio output section 221 of the television receiving device 100. The output section 503 performs display outputting of video information on the screen, and audio outputting of audio information through a speaker or the like.

The sensor section 504 basically includes the sensor group 400 in FIG. 4. The sensor section 504 includes at least the camera 413 that photographs a room (or installation environment) where the television receiving device 100 is placed. In addition, it is preferable that the sensor section 504 includes the environment sensor section 430 in order to detect a room environment where the television receiving device 100 is placed.

It is more preferable that the sensor section 504 includes the camera 411 that photographs the user who is viewing video content being displayed on the display section 219, the user state sensor section 420 that acquires state information regarding a user state, and the user profile sensor section 450 that detects profile information regarding the user.

A first recognition section 505 recognizes the room environment where the television receiving device 100 is placed, and information regarding the user who is viewing the television receiving device 100, on the basis of sensor information outputted from the sensor section 504. For example, the first recognition section 505 includes the main control section 201 of the television receiving device 100.

The first recognition section 505 recognizes, as the room environment, objects that are sparsely present in the room, pieces of furniture such as a dining table and a couch (the furniture category, e.g. British style, of each niece is also recognized), the raw materials of a cushion and a carpet on the floor, total space arrangement in the room, the incident direction of natural light from a window, and the like, on the basis of sensor information outputted from the sensor section 503.

In addition, the first recognition section 505 recognizes, as the information regarding the user, information regarding a user state and personal information regarding the profile of the user, on the basis of sensor information obtained by the user state sensor section 420 and the user profile sensor section 450. Examples of the information regarding a user state include a user working state (whether or not the user is viewing video content), a user action state (movement state such as standing still, walking, or running, the open or closed state of eyelids, the direction of the visual line, or whether the pupils are large/small), a mental state (an impression level, an excitement level, or an arousal level indicating how deeply the user is absorbed in or is concentrating on the video content, and feelings, emotions, etc.), and a physiological condition. In addition, examples of the user personal information include the tastes of the user, a schedule, and confidential information such as the sex and age, the details of the family, and the occupation.

In the present embodiment, the first recognition section 505 is configured to, by using a neural network having learned a correlation between sensor information and a room environment/user information, perform a process of recognizing the room environment and the user information.

A second recognition section 506 performs a process of recognizing a use state indicating whether the user is using the television receiving device 100. The second recognition section 506 basically performs the process of recognizing a use state indicating whether the user is using the television receiving device 100, according to the operating state (the power state indicating whether the power is on, off, or on standby, whether muting is set or not, or the like) of, mainly, a content output system in the television receiving device 100. For example, the second recognition section 506 includes the main control section 201 of the television receiving device 100.

In addition, the second recognition section 506 may perform the process of recognizing the use state indicating whether the user is using the television receiving device 100 on the basis of sensor information outputted from the sensor section 503. The second recognition section 506 may recognize the use state indicating whether the user is using the television receiving device 100, on the basis of sensor information obtained by the user state sensor section 420 and the user profile sensor section 450. For example, the second recognition section 506 recognizes that the television receiving device 100 is in a non-use state when the user is out, on the basis of information regarding the user's schedule. In addition, the second recognition section 506 may recognize that the television receiving device 100 is in a non-use state when the user's closely-viewing level for a video being displayed on the screen of the television receiving device 100 is less than a prescribed level. Moreover, the second recognition section 506 may recognize that the television receiving device 100 is in a non-use state when a change of a user's emotion measured by the user state sensor section 420 is irrelevant to the context of content outputted from the output section 503 (for example, when the user is not interested in a climactic scene of a movie or a drama series). By using a neural network having learned the correlation between sensor information and a use state, the second recognition section 506 may perform the process of recognizing the use state indicating whether the user is using the television receiving device 100.

Further, when the second recognition section 506 recognizes a non-use state in which the user is not using the television receiving device 100, the content deriving section 507 derives, on the basis of the recognition result obtained by the first recognition section 505, content to be outputted by the television receiving device 100 in order to make the television receiving device 100 blend into the interior. For example, the content deriving section 507 includes the main control section 201 of the television receiving device 100. In the present embodiment, a neural network having learned a correlation between a room environment/user information and content for assimilation into the interior is used to derive proper content. Then, the content derived by the content deriving section 507 is outputted to the reception section 501, is subjected to proper signal processing at the signal processing section 502, and then, is outputted from the output section 503. The content deriving section 507 may derive, from content stored in the television receiving device 100, content to be outputted during a non-use state, or may derive, from content available on a cloud, content to be outputted during a non-use state. The content deriving section 507 outputs a content ID for identifying the content, and a URL or URL indicating an area where the content is saved. In addition, the content deriving section 507 may generate proper content to be outputted during a non-use state.

Here, the content deriving section 507 derives content that matches another interior decoration in the room recognized by the first recognition section 505, or derives content that is suitable to the tastes of the user recognized by the first recognition section 505. When the content derived by the content deriving section 507 is outputted, the television receiving device 100 blends into the interior of the room. Accordingly, the large screen in a non-use state is inhibited from oppressing or overwearing the user.

As the content that is suitable to the interior of the room or the tastes of the user, video content is basically derived by the content deriving section 507. In addition, not only the video content but also audio content may be derived by the content deriving section 507. In the latter case, the output section 503 performs audio outputting simultaneously with screen display.

The main feature of the present embodiment is causing the content deriving section 507 to perform the content deriving process by using a neural network that has learned a correlation between a room environment/user's tastes and content.

Furthermore, a neural network that the first recognition section 505 uses for recognizing the room environment and the tastes of the user and a neural network that the content deriving section 507 uses for deriving content may be combined together, that is, the first recognition section 505 and the content deriving section 507 may be formed as one component such that a neural network having learned a correlation between sensor information and content is used to derive content.

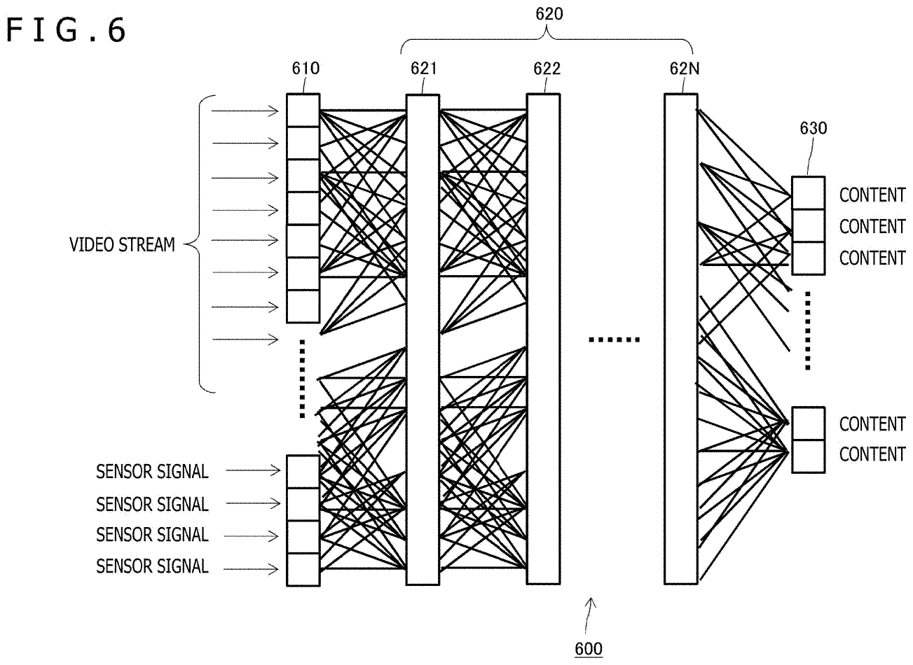

FIG. 6 depicts a configuration example of a content deriving neural network 600 obtained by combining the first recognition section 505 and the content deriving section 507 together. The content deriving neural network 600 has learned a correlation between sensor information and content. The content deriving neural network 600 includes an input layer 610 to which an image photographed by the camera 411 and any other sensor signals are inputted, an intermediate layer 620, and an output layer 630 which outputs content. In the example in FIG. 6, the intermediate layer 620 includes a plurality of intermediate layers 621, 622, . . . , so that the content deriving neural network 600 can perform DL. It is to be noted that, in order to process, as sensor signals, time-series information such as a moving image or audio, a recurrent neural network (RNN) structure including recursive connection in the intermediate layer 620 may be adopted.

The input layer 610 includes one or more input nodes that respectively receive one or more sensor signals included in the sensor group 400 in FIG. 4. In addition, input vector elements in the input layer 610 include a moving image stream (or stationary image) photographed by the camera 411. While basically remaining in a RAW data state, an image signal which is obtained by photographing by the camera 411 is inputted to the input layer 610.

It is to be noted that, in a case where not only the sensor signals of images photographed by the camera 411 but also sensor signals from any other sensors are used for recognizing the room environment and the tastes of the user, input nodes corresponding to the sensor signals are additionally arranged in the input layer 610. Further, when an image signal is inputted, a convolutional neural network (CNN) may be used to perform a process of compressing feature points.

On the basis of sensor information acquired by the sensor group 400, the room environment where the television receiving device 100 is placed and the tastes of the user are recognized. In addition, the output layer 630 includes a plurality of output nodes corresponding to different types of content. Further, when the second recognition section 506 recognizes a non-use state of the television receiving device 100, an output node that corresponds to content most likely suitable to the room environment or the tastes of the user is ignited on the basis of sensor information inputted to the input layer 610 at the recognition time.

It is to be noted that each of the output nodes may output a video signal and an audio signal of content, and further output a content ID for identifying the content and an URL or URI indicating an area where the content is saved.

In a case where a video signal and an audio signal are outputted from the content deriving neural network 600 serving as the content deriving section 507, the signals are transmitted to the signal processing section 502 through the reception section 501, are subjected to signal processing such as image-quality enhancement and sound-quality enhancement, and then, are outputted from the output section 503.

In addition, in a case where a content ID and a URL or URI are outputted from the content deriving neural network 600, the reception section 501 performs data search on a cloud, retrieves the corresponding content from the cloud, and transmits the content to the signal processing section 502. Then, the signal processing section 502 performs signal processing such as image-quality enhancement or sound-quality enhancement on the content, and outputs the content from the output section 503.

During a learning process in the content deriving neural network 600, a large quantity of combinations between sensor information and ideal content to be outputted by the television receiving device 100 that is in a non-use state, is inputted to the content deriving neural network 600, and the weight coefficients of the respective nodes in the intermediate layer 620 are updated so as to increase the strength of connection with an output node corresponding to content that is most likely to match sensor information (i.e. the room environment and the tastes of the user). In this manner, a correlation between a room environment/user's tastes and content is learned. For example, a user in an environment in which there are British-style furnishings, likes the Union Jack and British fork songs. If a user's hobby is surfing, there are a surfboard and marine-related furnishings in a user's room, and the user likes beach landscapes and beach sounds. Teacher data on such a correlation between a room environment/the tastes of a user and content is inputted to the content deriving neural network 600. Then, the content deriving neural network 600 sequentially finds content to be suitably outputted by the television receiving device 100 that is in a non-use state with respect to the room environment and the tastes of the user.

During a process of identification (assimilation into the interior) by the content deriving neural network 600, the content deriving neural network 600 outputs, with high degree of certainty, content that is suitable to be outputted by the television receiving device 100 in a non-use state, with respect to inputted sensor information (the room environment and the tastes of the user inputted at the point of time). In order to realize an operation outputted from the output layer 630, the main control section 201 comprehensively controls operation of the entire television receiving device 100.

The content deriving neural network 600 in FIG. 6 is implemented in the main control section 201, for example. Therefore, a processor for the neural network only may be included in the main control section 201. Alternatively, the content deriving neural network 600 may be provided by a cloud on the internet. However, it is preferable that the content deriving neural network 600 is disposed in the television receiving device 100 in order to generate content that is suitable for the room environment and the tastes of the user in real time because the television receiving device 100 is switched between a use state and a non-use state.

For example, the television receiving device 100 in which the content deriving neural network 600 that has completed learning using an expert instruction database is installed is shipped. The content deriving neural network. 600 may continue learning by using an algorithm of backpropagation or the like. Alternatively, a result of learning performed on the basis of data collected from many users through a cloud on the internet can be updated for the content deriving neural network 600 of the television receiving device 100 which is set in a house. This will be explained later.

E. Specific Example of Assimilation into Interior

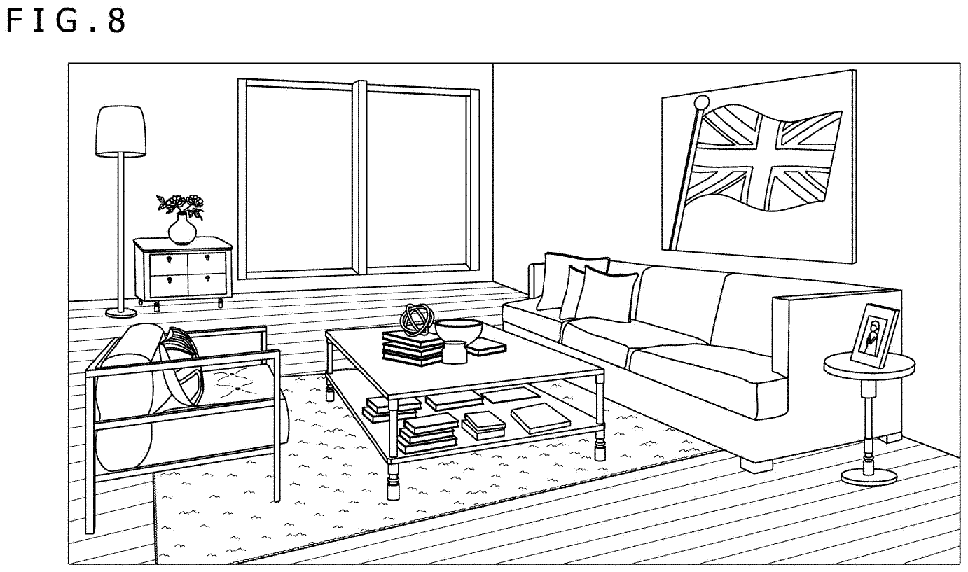

FIGS. 8 to 10 each depict a situation in which, while the television receiving device 100 according to the present embodiment is in a non-use state, the content assimilation system 500 in FIG. 5 is actuated to output video or audio content that matches a room environment or the tastes of a user such that assimilation into the interior of the room is achieved. FIGS. 8 to 10 each assume that the television receiving device 100 having a wall mounted type large screen is placed on the right-side wall of the room.

In the example depicted in FIG. 8, it is inferred that the user likes the British style because there are British style furnishings in the room.

On the basis of sensor information outputted from the sensor section 504, the first recognition section 505 recognizes that there are British-style furnishings such as couches and a couch table, and a British-style object on the couch table. In addition, the first recognition section 505 recognizes that the national flag of the United Kingdom, which is known as the Union Jack, is printed on a cushion on the couch, and there are piles of books of the British literature are in the room (on the couch table, on a rack, or the like). In addition, the first recognition section 505 performs image analysis of a picture in a photo stand on a side table beside the couch, and recognizes a subject in the picture and a place where the picture was taken. Moreover, on the basis of sensor information outputted from the user profile sensor section 450, the first recognition section 505 recognizes that the user has deep connection with England. For example, the first recognition section 505 recognizes that the user has many acquaintances in England, and has experience studying in England or has visited England.

On the basis of the recognition result obtained by the first recognition section 505, indicating that there are the British-style furnishings in the room and the user has deep connection with England, the content deriving section 507 derives, as content that blends into the interior of the room and matches the tastes of the user, a video of the national flag of the United Kingdom. The video of the national flag of the United Kingdom may be a stationary image of the Union Jack pattern, or may be a moving image showing that a cloth on which the national flag is printed is blowing in wind. In addition, the content deriving section 507 may further derive audio content of an English fork song or Euro-beat music, which blends into the interior of the room, is suitable to the tastes of the user, and is also suitable to the video of the national flag of the United Kingdom.

When the second recognition section 506 recognizes a non-use state of the television receiving device 100, the video content of the national flag of the United Kingdom is displayed on the large screen (the display section 219 of the television receiving device 100) on the right-side wall of the room, as depicted in FIG. 8. In addition, the audio output section 221 may output audio content of an English fork song or Euro-beat music, according to the video display of the national flag of the United Kingdom.

It is to be noted that the first recognition section 505 may further recognize a light source such as natural light. (sunlight) coming from a window of the room. On the basis of the light direction of the recognized light source, the content deriving section 507 may give a 3D effect so as to put a shine or a shadow on the national flag of the United Kingdom.

In the operation example in FIG. 8, the television receiving device 100 that is in a non-use state becomes an interior decoration that matches the other interior decorations in the room or that is suitable to the tastes of the user such that the television receiving device 100 can blend into the interior. In addition, the large screen of the television receiving device 100 that is in a non-use state is inhibited from oppressing or overwearing the user near the television receiving device 100. Accordingly, an unpleasant feeling is not given to the user.

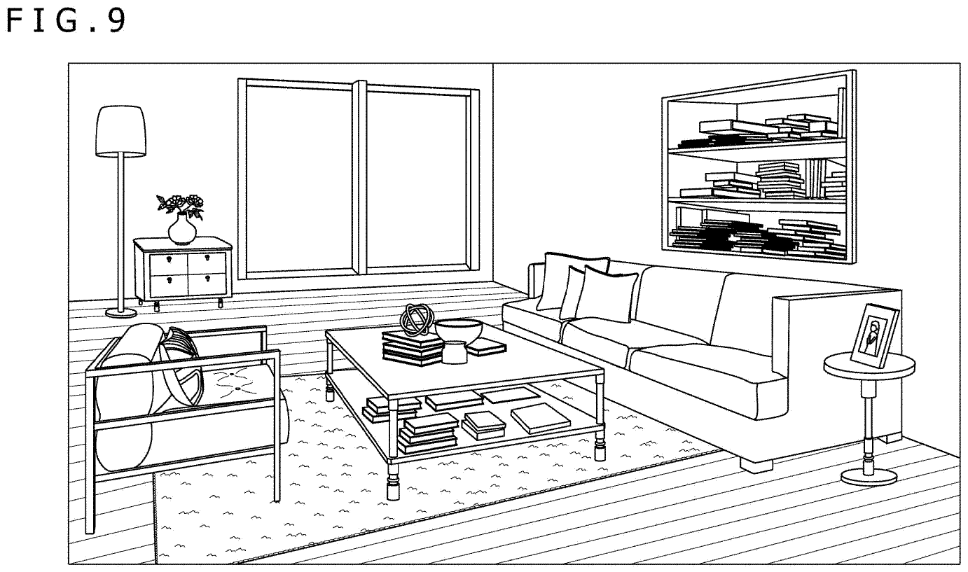

Also in the example in FIG. 9, there are British style furnishings in the room. Therefore, it is inferred that a user likes the British style.

On the basis of sensor information outputted from the sensor section 504, the first recognition section 505 recognizes that there are British-style furnishings such as couches and a couch table, and a British-style object on the couch table. In addition, the first recognition section 505 recognizes that the national flag of the United Kingdom, which is known as the Union Jack, is printed on a cushion on the couch, and there are piles of books of the British literature (on the couch table, on a rack, or the like) in the room. In addition, the first recognition section 505 performs image analysis of a picture in a photo stand on a side table beside the couch, and recognizes a subject in the picture and a place where the picture was taken. Furthermore, on the basis of the sensor information outputted from the user profile sensor section 450, the first recognition section 505 recognizes that the user is interested particularly in the English literature because the user likes reading, or has experience studying in England or has visited England.

On the basis of the recognition result obtained by the first recognition section 505 indicating that there are the British-style furnishings in the room and the user likes reading, the content deriving section 507 derives, as content that blends into the interior of the room and is suitable to the tastes of the user, a video of a bookshelf on which many books are piled. The image of the bookshelf may be a stationary image or a moving image. In addition, the content deriving section 507 may derive audio content of an English fork song or Euro-beat music, which blends into the interior of the room, and further, is suitable to the tastes of the user.

When the second recognition section 506 recognizes a non-use state of the television receiving device 100, the video content of the bookshelf is displayed on the large screen (the display section 219 of the television receiving device 100) on the right-side wall of the room, as depicted in FIG. 9. In addition, the audio output section 221 may output audio content of an English fork song or Euro-beat music, according to the video display of the national flag of the United Kingdom.

It is to be noted that the first recognition section 505 may further recognize a light source such as natural light (sunlight) coming from a window of the room. On the basis of the light direction of the recognized light source, the content deriving section 507 may give a 3D effect so as to put a shine or a shadow on the bookshelf or the books on the bookshelf. In addition, the first recognition section 505 may recognize the raw materials of a flooring and the furnishings in the room, and the content deriving section 507 may derive video content of a bookshelf that matches the raw materials actually disposed in the room.

In the operation example in FIG. 9, the television receiving device 100 that is in a non-use state becomes an interior decoration that matches the other interior decorations in the room or that is suitable to the tastes of the user such that the television receiving device 100 can blend into the interior. In addition, the large screen of the television receiving device 100 that is in a non-use state is inhibited from oppressing or overwearing the user near the television receiving device 100. Accordingly, an unpleasant feeling is not given to the user.

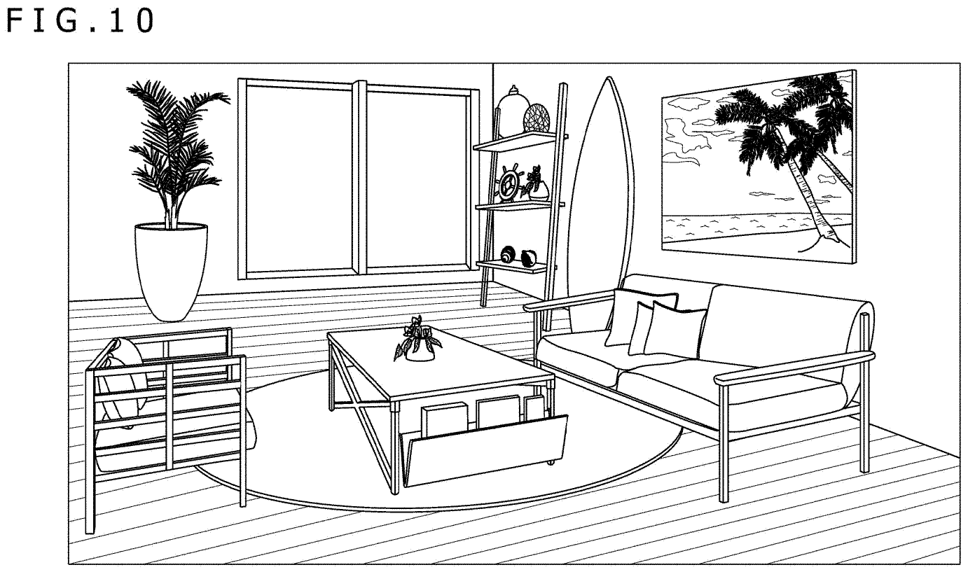

In the example depicted in FIG. 10, there are a surfboard, beach house-style furnishings such as table and benches in the room, and there also are objects such as a foliage plant and a shell. Therefore, it is inferred that the user likes beaches or marine sports.

On the basis of sensor information outputted from the sensor section 504, the first recognition section 505 recognizes that there are marine sports goods such as a surfboard. In addition, the first recognition section 505 recognizes that there are beach-house style furnishings such as benches, a table, a shelf, etc. In addition, the first recognition section 505 recognizes that a beach-style object such as a spiral shell is placed on the shelf. Further, on the basis of sensor information outputted from the user profile sensor section 450, the first recognition section 505 recognizes that the user's hobbies are surfing, scuba diving, and sea fishing, and that the user often goes surfing, scuba diving, and sea fishing.

On the basis of the recognition result obtained by the first recognition section 505 indicating that there are the beach house-style furnishings in the room and the user likes marine sports, the content deriving section 507 derives, as content that blends into the interior of the room and that is suitable to the tastes of the user, a video of a beach. The video of a beach may be a stationary image or a moving image showing that a tide is ebbing and flowing. In addition, the content deriving section 507 may further derive audio content of beach sounds which blends into the interior of the room, is suitable to the tastes of the user, and further, is suitable to the video of the beach.

When the second recognition section 506 recognizes a non-use state of the television receiving device 100, the video content of a beach is displayed on the large screen (the display section 219 of the television receiving device 100) on the right-side wall of the room, as depicted in FIG. 10. In addition, the audio output section 221 may output audio content of beach sounds, according to the video display of the beach.

In the operation example depicted in FIG. 10, the television receiving device 100 that is in a non-use state becomes an interior decoration that matches the other interior decorations in the room or that is suitable to the tastes of the user, so that the television receiving device 100 can blend into the interior. In addition, the large screen of the television receiving device 100 that is in a non-use state is inhibited from oppressing or overwearing the user near the television receiving device 100. Accordingly, an unpleasant feeling is not given to the user.

### F. Updating and Customizing Neural Network

The content deriving neural network 600 which is used during a process of assimilating the television receiving device 100 that is in a non-use state into the interior of a room on the basis of sensor information, has been explained so far.

The content deriving neural network 600 operates in the television receiving device 100 which is placed in a house and which can be directly operated by a user, or operates in an operating environment (hereinafter, also referred to as a “local environment”) such as a house where the device is placed, for example. One of effects provided by operating the content deriving neural network 600 for implementing an artificial intelligence function in a local environment, is to easily enable real-time learning of a user feedback, etc. as teacher data by using an algorithm of backpropagation or the like, for example. That is, as a result of direct learning using a user feedback, the content deriving neural network 600 can be customized or personalized to a particular user.

The user feedback is an evaluation made by a user when video and audio content derived by the content deriving neural network 600 is outputted by the television receiving device 100 that is in a non-use state. The user feedback may be so simple (or may a binary evaluation) that only OK (good) or NG (not, good) is indicated, and may be a multilevel evaluation. Alternatively, an evaluation comment spoken by the user in response to the content for assimilation into the interior outputted by the television receiving device 100 that is in a non-use state, may be inputted by audio inputting. The evaluation comment may be regarded as a user feedback. The user feedback is inputted to the television receiving device 100 via the operation input section 222, a remote controller, a voice agent which is one embodiment of an artificial intelligence, or a cooperated smartphone, for example. Further, when the content for assimilation into the interior is outputted by the television receiving device 100 that is in a non-use state, a user's mental state or physiological condition detected by the user-state sensor section 420 may be regarded as the user feedback.

Meanwhile, in one or more server devices (hereinafter, also simply referred to as “cloud”) that operate on a cloud which is a group of server devices on the internet, data may be collected from a great number of users, and learning by a neural network may be repeated to implement an artificial intelligence function. Results of the learning may be used to update the content deriving neural network 600 in the television receiving device 100 in each house. One of effects provided by updating of a neural network that exerts an artificial intelligence function on a cloud, is to construct a high-precision neural network because a large quantity of data is used to perform learning.

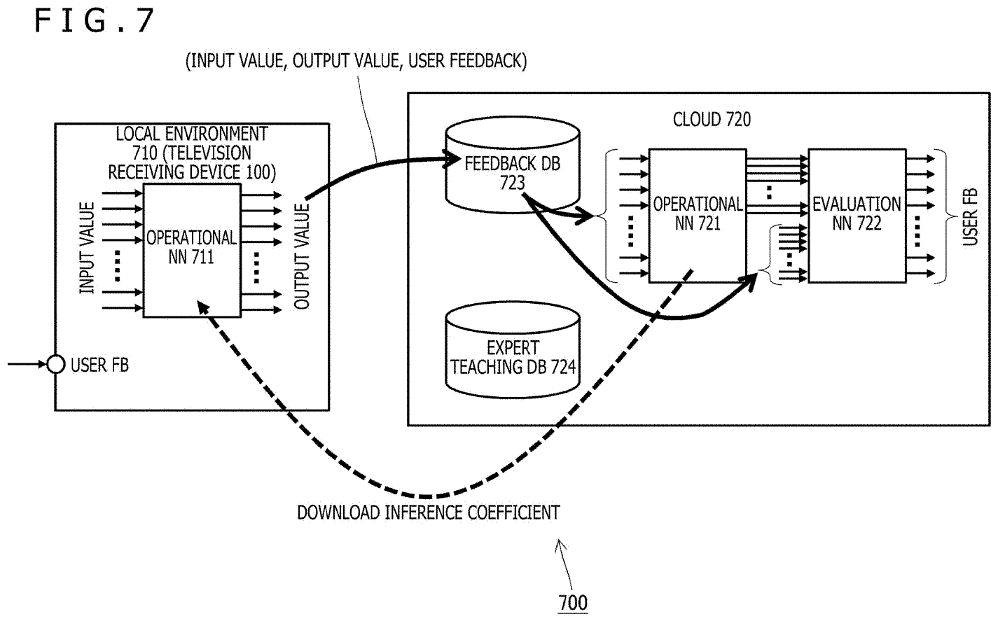

FIG. 7 schematically depicts a configuration example of an artificial intelligence system 700 using a cloud. The depicted artificial intelligence system 700 using a cloud includes a local environment 710 and a cloud 720.

The local environment 710 corresponds to an operating environment (house) where the television receiving device 100 is placed, or to the television receiving device 100 placed in a house. For the sake of simplicity, only one local environment 710 is depicted in FIG. 7. However, it is assumed that a great number of local environments are actually connected to one cloud 720. In the present embodiment, the local environment 710 is mainly described as an example of an operating environment such as a house where the television receiving device 100 operates. The local environment 710 may be an environment where any device such as a smartphone, a tablet, or a personal computer having a screen for displaying content, operates. Examples of such an environment include a public facility such as a station, a bus stop, an airport, or a shopping center, and a working facility such as a factory or an office.

As explained above, as an artificial intelligence, the content deriving neural network 600 for deriving content for assimilation into an interior is disposed in the television receiving device 100. A neural network that is installed in the television receiving device 100 and that is actually used, is generally referred to as operational neural network 711, herein. It is assumed that, by using an expert instruction database including a great quantity of sample data, the operational neural network 711 has learned a correlation between sensor information (or the room environment and the tastes of the user) and content for assimilation into the interior to be outputted by the television receiving device 100 that is in a non-use state into the interior.

An artificial intelligence server (explained above) for providing an artificial intelligence function (at least one server device is included) is mounted on the cloud 720. In the artificial intelligence server, an operational neural network 721 and an evaluation neural network 722 that evaluates the operational neural network 721 are disposed. The configuration of the operational neural network 721 is the same as that of the operational neural network 711 disposed in the local environment 710. It is to be assumed that a correlation between sensor information (or the room environment and the tastes of the user) and content for assimilation into the interior to be outputted by the television receiving device 100 that is in a non-use state into the interior has been learned with use of an expert instruction database 724 including a great quantity of sample data. In addition, the evaluation neural network 722 is used for evaluating the learning state of the operational neural network 721.

On the local environment 710 side, the operational neural network 711 receives the sensor information from the user state sensor section 420, the user profile sensor section 450, and the like, and outputs the content for assimilation into the interior to be outputted by the television receiving device 100 that is in a non-use state (in the case where the content deriving neural network 600 is used as the operational neural network 711). Here, for the sake of simplicity, an input to the operational neural network 711 and an output from the operational neural network 712 are simply referred to as “input value” and “output value,” respectively.

The user (e.g. a person viewing the television receiving device 100) in the local environment 710 evaluates an output value from the operational neural network 711, and feeds an evaluation result back to the television receiving device 100, via the operation input section 222, a remote controller, a voice agent, a smartphone cooperated, or the like. Here, for the sake of simplicity of explanation, it is assumed that the user feedback indicates OK (0) or NG (1). That is, whether or not the user likes the content for assimilation into the interior outputted by the television receiving device 100 that is in a non-use state, is indicated by either OK (0) or NG (1).

Feedback data which is a set of the input value and output value of the operational neural network 711 and the user feedback is transmitted from the local environment 710 to the cloud 720. In the cloud 720, the feedback data transmitted from a great number of the local environments is stored in a feedback database 723. A great quantity of the feedback data in which correlations between input values and output values of the operational neural network 711 and the user are written, is stored in the feedback database 723.

In addition, the cloud 720 has or can use the expert instruction database 724 including a great quantity of sample data used for preliminary learning by the operational neural network 711. Each of the sample data sets is teacher data in which a correlation between sensor information and an output value (content for assimilation into the interior to be outputted by the television receiving device 100 that is in a non-use state) of the operational neural network 711 (or 721) is written.

When feedback data is extracted from the feedback database 723, an input value (e.g. sensor information) included in the feedback data is inputted to the operational neural network 721. In addition, an output value (content for assimilation to the interior to be outputted by the television receiving device 100 that is in a non-use state) of the operational neural network 721, and an input value (e.g. sensor information) included in corresponding feedback data, are inputted to the evaluation neural network 722, and then, the evaluation neural network 722 outputs an estimated value of a user feedback.

In the cloud 720, a first step of performing learning in the evaluation neural network 722, and a second step of performing learning in the operational neural network 721 are alternately executed.

The evaluation neural network 722 learns a correspondence between an input value to the operational neural network 721 and a user feedback for an output from the operational neural network 721. Therefore, in the first step, an output value of the operational neural network 721 and a user feedback included in the corresponding feedback data are inputted to the evaluation neural network 722. On the basis of the difference between a user feedback that is outputted from the evaluation neural network 722 in response to the output value of the operational neural network 721 and a user feedback that is actually given in response to the output value of the operational neural network 721, a loss function is defined, and learning is performed so as to minimize the loss function. As a result of this, learning is performed in such a way that, in response to an output of the operational neural network 721, the evaluation neural network 722 outputs a user feedback (OK or NG) that is equal to one from an actual user.

Next, in the second step, while the evaluation neural network 722 is fixed, learning by the operational neural network 721 is performed. When feedback data is extracted from the feedback database 723, in the aforementioned manner, an input value included in the feedback data is inputted to the operational neural network 721, and an output value of the operational neural network 721 and corresponding user feedback data included in the feedback data are inputted to the evaluation neural network 722. Accordingly, the evaluation neural network 722 outputs a user feedback that is equal to one from an actual user.

Here, by applying the loss function to an output from an output layer in the operational neural network 721, the operational neural network 721 performs learning using backpropagation in such a way that the value of the output becomes minimum. For example, in a case where a user feedback is used as teacher data, the operational neural network 721 inputs, into the evaluation neural network 722, an output value (content to be outputted by the television receiving device 100 that is in a non-use state) of the operational neural network 721 in response to a great number of input values (e.g. sensor information), and performs learning in such a way that all user evaluations estimated by the evaluation neural network 722 indicate OK (0). As a result of this learning, in response to any input value (sensor information), the operational neural network 721 can output an output value (content for assimilation into the interior to be outputted by the television receiving device 100 that is in a non-use state) which the user feedback indicates OK (0).

During the learning by the operational neural network 721, the expert instruction database 724 may be used as teacher data. In addition, two or more types of teacher data such as a user feedback and the expert instruction database 724, may be used to perform the learning. In this case, the loss functions calculated for respective pieces of teacher data may be weighted and added to be minimized. Thus, the learning by the operational neural network 721 may be performed.

The aforementioned first step of performing learning in the evaluation neural network 722, and the aforementioned second step of performing learning in the operational neural network 721 are alternately executed, so that the output accuracy of the operational neural network 721 is enhanced. Further, an inference coefficient in the operational neural network 721 having the precision enhanced by the learning is provided to the operational neural network 711 in the local environment 710. Accordingly, the user also can enjoy the operational neural network 711 having advanced the learning. As a result, the degree of assimilation of content outputted by the television receiving device 100 that is in a non-use state, into the interior of the room is enhanced.

A method for providing, to the local environment 710, an inference coefficient the accuracy of which has been enhanced in the cloud 720, is optionally decided. For example, a bit stream of the inference coefficient in the operational neural network 711 may be compressed so as to be downloaded from the cloud 720 to the local environment 710. In a case where the size of the compressed bit stream is still large, the inference coefficient may be divided in each layer or each region such that the compressed bit streams are downloaded multiple times.

### INDUSTRIAL APPLICABILITY

The details of the technology according to the present disclosure have been explained so far, with reference to the specific embodiments. However, it is obvious that modification or replacement can be made within the gist of the technology according to the present disclosure.

In the present specification, the embodiments in which the technology according to the present disclosure is applied to a television receiver have been mainly explained. However, the gist of the technology according to the present disclosure is not limited to these embodiments. The technology according to the present disclosure is also applicable to a display device, a reproduction device, or a content acquisition device that acquire various types of video and audio reproduction content through streaming or downloading via broadcast waves or the internet, and present the content to a user, or that has a reproduction function-mounted display.

That is, the technology according to the present disclosure has been explained in a form of exemplification, and the present specification should not be limitedly interpreted. In order to assess the gist of the technology according to the present disclosure, the claims should be taken into consideration.

It is to be noted that the technology disclosed herein can also have the following configurations.

(1) An information processing device for controlling operation of a display device by using an artificial intelligence function, the device including:

an acquisition section that acquires sensor information; and

an inferring section that infers content, which is to be outputted by the display device according to a use state, by using the artificial intelligence function, on the basis of the sensor information.

(2) The information processing device according to (1), in which

the inferring section infers content, which is to be outputted by the display device that is in a non-use state, by using the artificial intelligence function.

(3) The information processing device according to (1) or (2), further including:

a second inferring section that infers a use state of the display device.

(4) The information processing device according to (3), in which

the second inferring section infers a use state of the display device, by using the artificial intelligence function, on the basis of the sensor information.

(5) The information processing device according to any one of (1) to (4), in which

the inferring section infers the content, which is to be outputted by the display device that is in a non-use state, by using the artificial intelligence function on the basis of information regarding a room where the display device is placed, the information regarding the room being included in the sensor information.

(6) The information processing device according to (5), in which

the information regarding the room includes at least one of information regarding a piece of furniture or a furnishing in the room, a raw material of the piece of furniture or the furnishing, and information regarding a light source in the room.

(7) The information processing device according to any one of (1) to (6), in which

the inferring section infers video content, which is to be displayed on the display device that is in a non-use state, by using the artificial intelligence function, further on the basis of information regarding a user of the display device, the information regarding the user being included in the sensor information.

(8) The information processing device according to (7), in which

the information regarding the user includes at least one of information regarding a user state or information regarding a user profile.

(9) The information processing device according to any one of (1) to (8), in which

the inferring section infers video content, which is to be outputted by the display device that is in a non-use state, by using the artificial intelligence function.

(10) The information processing device according to any one of (1) to (9), in which

the inferring section further infers audio content, which is to be outputted by the display device that is in a non-use state, by using the artificial intelligence function.

(11) The information processing device according to any one of (1) to (10), in which by using a first neural network having learned a correlation between sensor information and content, the inferring section infers the content which is to be outputted by the display device that is in a non-use state.

(12) The information processing device according to (3) or (4), in which by using a second neural network having learned a correlation between sensor information and an operating state of the display device, the second inferring section infers the content which is to be outputted by the display device that is in a non-use state.

(13) An information processing method for controlling operation of a display device by using an artificial intelligence function, the method including: an acquisition step of acquiring sensor information; and

an inferring step of inferring content, which is to be outputted by the display device, on the basis of the sensor information by using the artificial intelligence unction.

(14) An artificial intelligence function-mounted display device including:

a display section;

an acquisition section that acquires sensor information; and

an inferring section that infers content, which is to be outputted from the display section, by using an artificial intelligence function, on the basis of the sensor information.

(15) The artificial intelligence function-mounted display device according to (14), in which

the inferring section infers content, which is to be outputted by the display device that is in a non-use state, by using the artificial intelligence function.

(16) The artificial intelligence function-mounted display device according to (14) or (15), further including:

a second inferring section that infers a use state of the display device.

(17) The artificial intelligence function-mounted display device according to (16), in which

the second inferring section infers a use state of the display device, by using the artificial intelligence function, on the basis of the sensor information.

(18) The artificial intelligence function-mounted display device according to any one of (14) to (17), in which

the inferring section infers the content, which is to be outputted by the display device that is in a non-use state, by using the artificial intelligence function on the basis of information regarding a room where the display device is placed, the information regarding the room being included in the sensor information.

(19) The artificial intelligence function-mounted display device according to (18), in which

the information regarding the room includes at least one of information regarding a piece of furniture or a furnishing in the room, a raw material of the piece of furniture or the furnishing, and information regarding a light source in the room.

(20) The artificial intelligence function-mounted display device according to any one of (14) to (19), in which

the inferring section infers video content, which is to be displayed on the display device that is in a non-use state, by using the artificial intelligence function, further on the basis of information regarding a user of the display device, the information regarding the user being included in the sensor information.

(21) The artificial intelligence function-mounted display device according to (20), in which

the information regarding the user includes at least one of information regarding a user state or information regarding a user profile.

(22) The artificial intelligence function-mounted display device according to any one of (14) to (21), in which

the inferring section infers video content, which is to be outputted by the display device that is in a non-use state, by using the artificial intelligence function.

(23) The artificial intelligence function-mounted display device according to any one of (14) to (22), in which

the inferring section further infers audio content, which is to be outputted by the display device that is in a non-use state, by using the artificial intelligence function.

### REFERENCE SIGNS LIST

100 . . . Television receiving device, 201 . . . Main control section, 202 . . . Bus
203 . . . Storage section, 204 . . . Communication interface (IF) section
205 . . . Extension interface (IF) section
206 . . . Tuner/demodulator section, 207 . . . Demultiplexer
208 . . . Video decoder, 209 . . . Audio decoder
210 . . . Character superimposition decoder, 211 . . . Subtitle decoder
212 . . . Subtitle synthesis section, 213 . . . Data decoder, 214 . . . Cache section
215 . . . Application (AP) control section, 216 . . . Browser section
217 . . . Sound source section, 218 . . . Video synthesis section, 219 . . . Display section
220 . . . Audio synthesis section, 221 . . . . Audio output section
222 . . . Operation input section
400 . . . Sensor group, 410 . . . Camera section, 411 to 413 . . . Camera
420 . . . User-state sensor section, 430 . . . Environment sensor section
440 . . . Device state sensor section, 450 . . . User profile sensor section
500 . . . Content assimilation system, 501 . . . Reception section
502 . . . Signal processing section, 503 . . . Output section, 504 . . . Sensor section
505 . . . First recognition section, 506 . . . Second recognition section
507 . . . Content deriving section
600 . . . Content deriving neural network, 610 . . . Input layer
620 . . . intermediate layer, 630 . . . Output layer
710 . . . Local environment, 711 . . . Operational neural network
720 . . . Cloud, 721 . . . Operational neural network
722 . . . Evaluation neural network
723 . . . Feedback database
724 . . . Expert teaching database

1. An information processing device for controlling operation of a display device by using an artificial intelligence function, the device comprising:
an acquisition section that acquires sensor information; and
an inferring section that infers content, which is to be outputted by the display device according to a use state, by using the artificial intelligence function, on a basis of the sensor information.

2. The information processing device according to claim 1, wherein
the inferring section infers content, which is to be outputted by the display device that is in a non-use state, by using the artificial intelligence function.

3. The information processing device according to claim 1, further comprising:
a second inferring section that infers a use state of the display device.

4. The information processing device according to claim 3, wherein
the second inferring section infers a use state of the display device, by using the artificial intelligence function, on the basis of the sensor information.

5. The information processing device according to claim 1, wherein
the inferring section infers the content, which is to be outputted by the display device that is in a non-use state, by using the artificial intelligence function, on a basis of information regarding a room where the display device is placed, the information regarding the room being included in the sensor information.

6. The information processing device according to claim 5, wherein
the information regarding the room includes at least one of information regarding a piece of furniture or a furnishing in the room, a raw material of the piece of furniture or the furnishing, and information regarding a light source in the room.

7. The information processing device according to claim 1, wherein
the inferring section infers video content, which is to be displayed on the display device that is in a non-use state, by using the artificial intelligence function, further on a basis of information regarding a user of the display device, the information regarding the user being included in the sensor information.

8. The information processing device according to claim 7, wherein
the information regarding the user includes at least one of information regarding a user state or information regarding a user profile.

9. The information processing device according to claim 1, wherein
the inferring section infers video content, which is to be outputted by the display device that is in a non-use state, by using the artificial intelligence function.

10. The information processing device according to claim 1, wherein
the inferring section further infers audio content, which is to be outputted by the display device that is in a non-use state, by using the artificial intelligence function.

11. The information processing device according to claim 1, wherein
by using a first neural network having learned a correlation between sensor information and content, the inferring section infers the content which is to be outputted by the display device that is in a non-use state.

12. The information processing device according to claim 3, wherein
by using a second neural network having learned a correlation between sensor information and an operating state of the display device, the second inferring section infers the content which is to be outputted by the display device that is in a non-use state.

13. An information processing method for controlling operation of a display device by using an artificial intelligence function, the method comprising:
an acquisition step of acquiring sensor information; and
an inferring step of inferring content, which is to be outputted by the display device, on a basis of the sensor information by using the artificial intelligence function.

14. An artificial intelligence function-mounted display device comprising:
a display section;
an acquisition section that acquires sensor information; and
an inferring section that infers content, which is to be outputted from the display section, by using an artificial intelligence function, on a basis of the sensor information.
